(19) United States
(12) Patent Application Publication
(10) Pub. No.: US 2025/0263966 A1
(43) Pub. Date: Aug. 21, 2025

(54) POWERED TRAILER SYSTEMS

(71) Applicant: ASSA ABLOY ENTRANCE SYSTEMS AB, LANDSKRONA (SE)

(72) Inventors: Richard K. Hoofard, Dallas, TX (US); L. Blake Whitley, Arlington, TX (US); Daryl Day, Frisco, TX (US)

(21) Appl. No.: 19/199,743

(22) Filed: May 6, 2025

Related U.S. Application Data
(63) Continuation of application No. 17/853,729, filed on Jun. 29, 2022, now Pat. No. 12,338,672.
(60) Provisional application No. 63/247,725, filed on Sep. 23, 2021.
(60) Provisional application No. 63/218,110, filed on Jul. 2, 2021.

(30) Foreign Application Priority Data
Nov. 30, 2021 (SE) 2130336-7
Nov. 30, 2021 (SE) 2130337-5
Nov. 30, 2021 (SE) 2130338-3
Nov. 30, 2021 (SE) 2130339-1

(51) Int. Cl. E05F 15/686

(52) U.S. Cl. CPC E05F 15/686; E05Y 2900/516; E05Y 2900/532

(57) ABSTRACT

The present disclosure is directed generally to powered trailer systems and, more particularly, to powered trailer systems for opening and closing trailer doors at, e.g., a vehicle loading dock, and to vehicle and/or trailer power delivery and charging systems. A powered trailer door operating system can include a guide track having a lower guide track portion and an upper guide track portion; a drive support coupled to the upper guide track portion having a drive shaft positioned within a central cavity; and a carriage slidingly coupled to the drive support and operably coupled to the trailer door. The carriage can be operably engaged with the drive shaft through the slot such that rotation of the drive shaft causes the carriage to translate along the drive support, thereby moving the trailer door between the open and closed positions.

### CROSS-REFERENCE TO RELATED APPLICATIONS

This application is a continuation of U.S. patent application Ser. No. 17/853,729, filed Jun. 29, 2022, and titled “POWERED TRAILER SYSTEMS,” which claims priority to U.S. Provisional Patent Application No. 63/218,110, filed Jul. 2, 2021, and titled “POWERED TRAILER DOOR SYSTEMS,” U.S. Provisional Patent Application No. 63/247,725, filed Sep. 23, 2021, and titled “POWERED TRAILER SYSTEMS,” Swedish Patent Application No. 2130336-7, filed Nov. 30, 2021, Swedish Patent Application No. 2130337-5, filed Nov. 30, 2021, Swedish Patent Application No. 2130338-3, filed Nov. 30, 2021, and Swedish Patent Application No. 2130339-1, filed Nov. 30, 2021, each of which is incorporated by reference herein in its entirety.

### TECHNICAL FIELD

The present disclosure is directed generally to powered trailer systems and, more particularly, to powered trailer systems for opening and closing trailer doors at, e.g., a vehicle loading dock, and to vehicle and/or trailer power delivery and charging systems.

### BACKGROUND

Vehicle docking facilities, such as warehouses, typically include multiple vehicle docking stations that facilitate the movement of goods between the facility and a vehicle parked at the docking station. Each vehicle docking station can include docking equipment used to improve the safety and efficiency of moving goods between the facility and the vehicle. A vehicle docking station can include, for example, a vehicle restraint used to ensure that the vehicle does not move away from the docking station during loading and unloading, a dock door used to control access into and out of the warehouse, a dock leveler used to provide a bridge or ramp between the vehicle and the facility, a barrier gate to prevent cargo or personnel from falling out of the docking station when the dock door is open, and an inflatable shelter to provide cover between the vehicle and the facility during loading and unloading. Once the vehicle is restrained and the dock door is opened, the trailer door must be opened to access the cargo within the trailer. Trailer doors are typically roll-up type doors or swing-type doors. Roll-up type doors are manually opened to access the cargo within the trailer once the vehicle is restrained and the dock door is opened. Swing-type trailer doors require dock personnel to manually open the doors for loading and/or unloading the trailer prior to backing the vehicle up to the dock and restraining the vehicle.

### BRIEF DESCRIPTION OF THE DRAWINGS

FIGS. 1A and 1B are isometric and cross-sectional elevation views, respectively, illustrating an automated trailer door system configured in accordance with embodiments of the present technology.

FIGS. 1C and 1D are isometric and plan views, respectively, illustrating a trailer power connection system configured in accordance with other embodiments of the present technology.

FIG. 1E is a plan view illustrating a trailer power connection system configured in accordance with further embodiments of the present technology.

FIG. 1F is a rear elevation view of a trailer illustrating components of a trailer power connection system configured in accordance with embodiments of the present technology.

FIGS. 2A and 2B are isometric and side elevation views, respectively, illustrating an automated trailer door system configured in accordance with other embodiments of the present technology.

FIGS. 3A-3C are isometric, side elevation, and cross-sectional detail views, respectively, illustrating an automated trailer door system configured in accordance with further embodiments of the present technology.

FIG. 4A is a perspective view illustrating a conventional trailer door latch system.

FIGS. 4B and 4C are perspective and cross-sectional elevation views, respectively, illustrating an automated trailer door latch system configured in accordance with embodiments of the present technology, and

FIGS. 4D and 4E are detail elevation views illustrating components of the automated trailer door latch system of FIGS. 4B and 4C.

FIGS. 5-7 are flowcharts of loading dock operational steps configured in accordance with embodiments of the present technology.

### DETAILED DESCRIPTION

The following disclosure describes various embodiments of powered trailer systems, including systems for automated opening and/or closing of trailer doors, e.g., while the trailer is at a loading dock, and systems for vehicle and/or trailer power delivery and charging. Embodiments of the automated trailer door systems described herein may be systems positioned within, or at least partially within, the trailer and suitable for opening and/or closing the trailer door by use of a drive system. Systems of the present technology may also include an internal drive component that receives power from the trailer and/or tractor and interfaces with a corresponding component on the trailer door assembly, e.g., a track, carriage, bracket, door panel, drive screw, etc. to open and/or close the trailer door. Although the following description is generally directed to embodiments of internally positioned automated trailer door systems for opening/closing of the trailer door, the present technology is not limited to such configurations and the systems described herein are suitable for use with other types of automated loading dock and/or trailer door systems. In some embodiments of the present technology, operation of the automated trailer door systems described herein may be controlled by a controller and/or other suitable processor system located at a loading dock, vehicle, or other location in response to, e.g., inputs from an operator and/or inputs from one or sensors (e.g., a trailer presence sensor, a trailer restraint sensor, etc.), computer applications, or other systems. The following disclosure also describes various embodiments of systems for vehicle and/or trailer power delivery and/or charging systems, e.g., while the vehicle/trailer is at a loading dock.

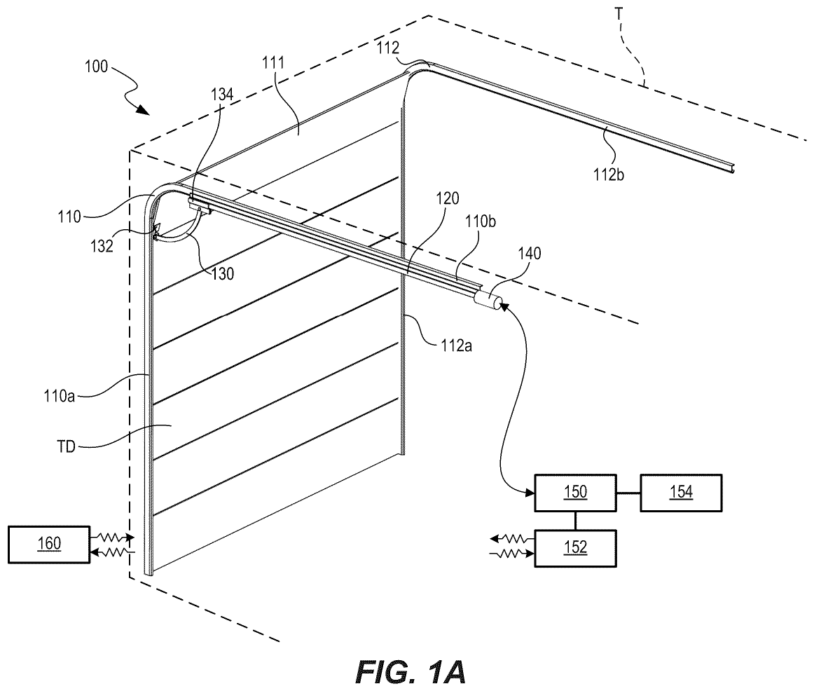

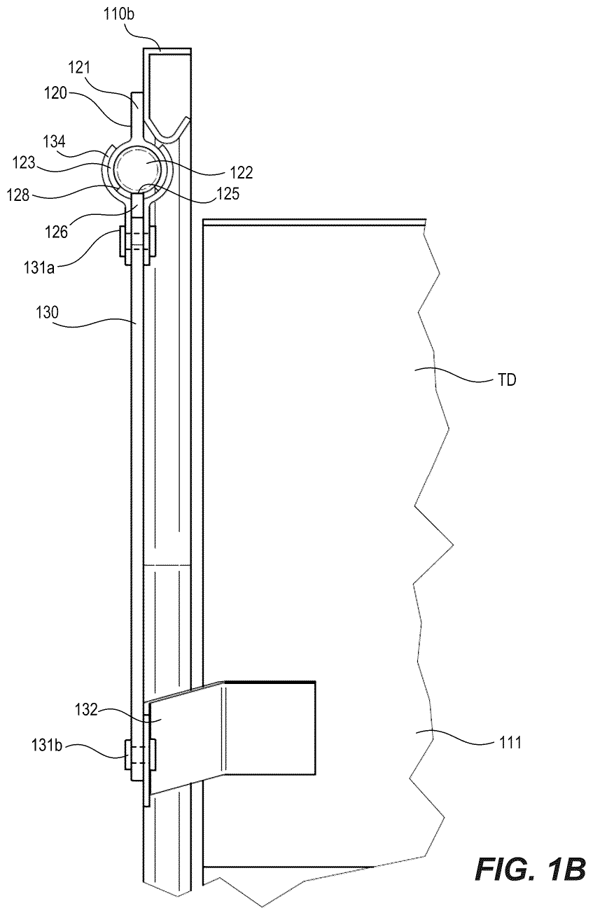

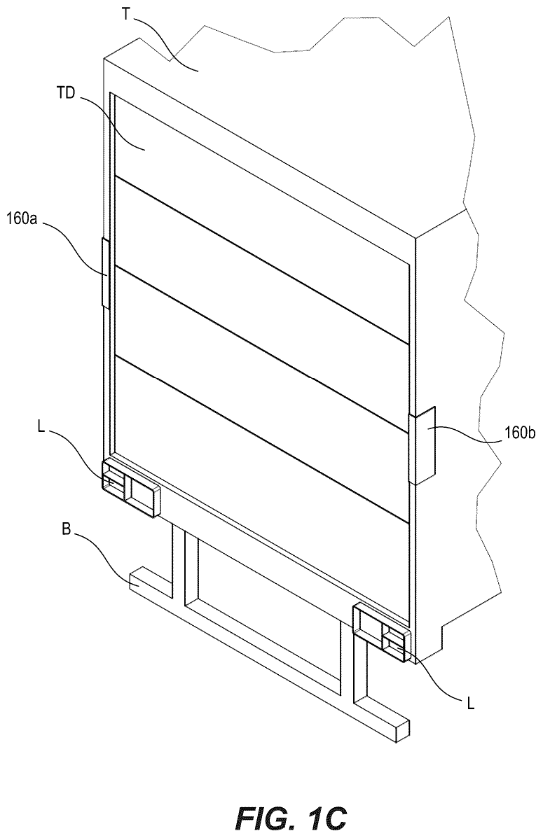

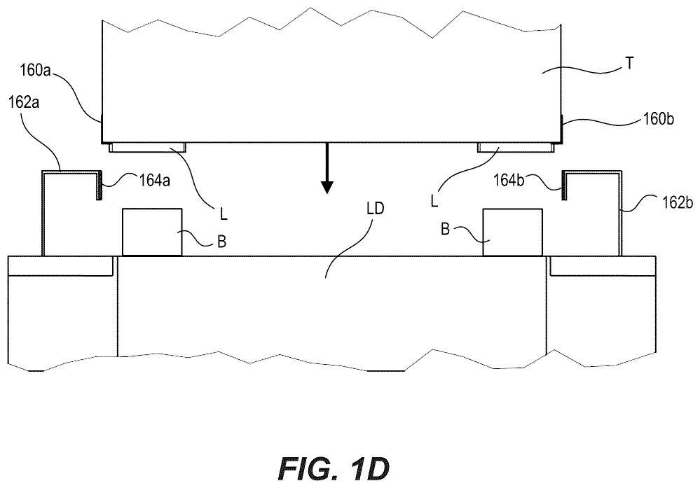

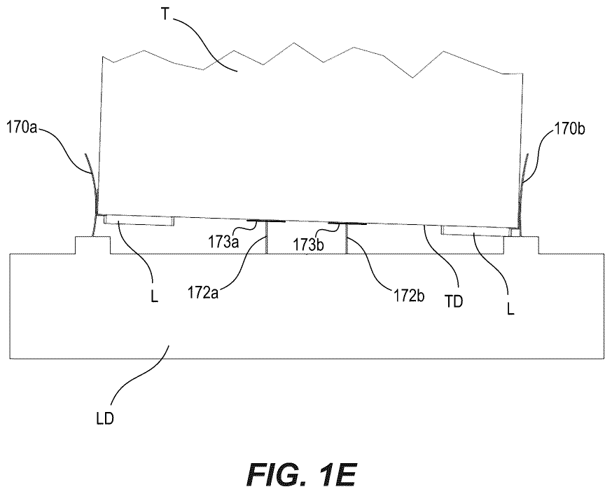

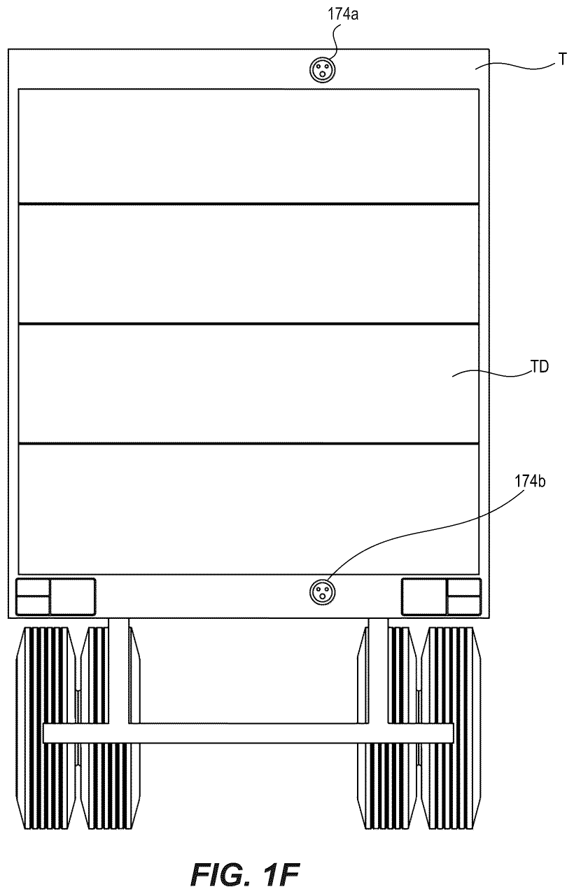

Certain details are set forth in the following description and in FIGS. 1A-7 to provide a thorough understanding of various embodiments of the present technology. By way of example, the systems, components and/or methods described herein may be configured for use with one or more of the systems described in U.S. patent application Ser. No. 17/829,057, filed May 31, 2022, and titled LOADING DOCK AUTOMATED TRAILER DOOR SYSTEMS, which is incorporated by reference herein in its entirety. In other instances, well-known structures, systems, materials and/or operations often associated with trailers, trailer door systems, loading docks, and associated components are not shown or described in detail in the following disclosure to avoid unnecessarily obscuring the description of the various embodiments of the technology. Those of ordinary skill in the art will recognize, however, that the present technology can be practiced without one or more of the details set forth herein, and/or with other structures, methods, components, and so forth. The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention. Additionally, many of the details, dimensions, angles and other features shown in the Figures are merely illustrative of particular embodiments of the disclosure. Accordingly, other embodiments can have other details, dimensions, angles and features without departing from the spirit or scope of the present invention. Those of ordinary skill in the art will also appreciate that further embodiments of the invention can be practiced without several of the details described below. In the Figures, identical reference numbers identify identical, or at least generally similar, elements.

In some embodiments of the present technology (see, e.g., FIG. 1A), an automated trailer door system 100 (“system 100”) includes components associated with a trailer door TD of a trailer T for opening and/or closing the trailer door TD. Some embodiments can include components that can interface with one or more components associated with a loading dock LD (see, e.g., FIGS. 1D and 1E). Referring first to FIGS. 1A and 1B, these figures are isometric and cross-sectional elevation views, respectively, illustrating the system 100 configured in accordance with embodiments of the present technology. The system 100 includes components associated with the trailer T that can automate the opening and/or closing of the trailer door TD in response to, e.g., a signal (.e.g., a wireless and/or wired signal) initiated by a tractor/trailer control system, a truck driver, from an operator at a loading dock, from a loading dock control system, etc. The system 100 includes a first guide track 110 and a second guide track 112, having lower guide track portions 110a and 112a, respectively, in a generally vertical orientation for retaining the sides of the trailer door TD when the trailer door TD is in the closed position, and upper guide track portions 110b and 112b, respectively, in a generally horizontal orientation for retaining the sides of the trailer door TD when the trailer door TD is in the open position above the trailer internal space. In some embodiments, the upper track portions 110b and 112b support the trailer door TD in a horizontal position so that the trailer door TD does not tend to move from the open position toward the closed position without actuation by the system 100 or manual input. Although not illustrated in FIGS. 1A and 1B, in some embodiments the trailer door TD can include a counterbalance having a shaft, spring, drum, cable, etc. to provide additional force to assist in opening the trailer door TD or to retain the trailer door TD in the closed position.

Referring to FIGS. 1A and 1B together, the system 100 further includes an elongate drive support 120 which can be operably coupled to either of the first and second guide tracks 110 and 112. FIG. 1B is shown with component 140 (representing a motor, as will be described below) omitted to better illustrate certain components of the system 100. As an example, in the illustrated embodiment the drive support 120 is operably coupled to the upper guide track portion 110b of the first guide track 110. More specifically, the drive support 120 can include an upper flange 121 that can be operably coupled to the upper guide track portion 110b by means of fasteners, welding, and/or other suitable attachment means (not shown). Although not shown in the Figures, in other embodiments, the drive support 120 can be operably coupled to one of the lower guide track portions 110a and 112a, a configuration in which the drive support 120 and the components of the system 100 described below would generally be rotated by 90° to align with the lower guide track portions 110a and 112a.

In the illustrated embodiment, the drive support 120 is configured to rotatably support a drive shaft 122 extending therethrough (see FIG. 1B). More specifically, in the illustrated embodiment, the drive support 120 has a semi-circular portion 123 that partially encloses the outer circumference of the drive shaft 122 therein, with an opening (e.g., a longitudinal slot 128 along the length of the drive support 120) such that a lower portion of the outer surface of the drive shaft 122 is accessible external to the drive support 120 through the longitudinal slot 128. The drive shaft 122 can be a threaded shaft with helical screw-type threads configured to operably engage (e.g., contact, interact with, etc.) teeth 125 of an engagement member 126 (e.g., a toothed rack or other suitable component) such that rotation of the drive shaft 122 about its longitudinal axis translates the engagement member 126 longitudinally fore and aft (depending on the direction of rotation of the drive shaft 122) along the drive shaft 122. The engagement member 126 can be operably coupled to a carriage 134 configured to partially surround and slidingly engage the semi-circular portion 123 of the drive support 120 to maintain the engagement member 126 in sliding engagement with the drive shaft 122 during opening and closing of the trailer door TD. Translation of the carriage 134 along the drive support 120 can move the trailer door TD in the guide tracks 110 and 112 by means of a door arm 130. In some embodiments, the door arm 130 includes a first end portion having a first pin 131a pivotably coupling the first end portion to the carriage 134 and a second end portion having a second pin 131b pivotally coupling the second end portion to a door bracket 132 that is operably coupled to an uppermost door panel 111. During opening or closing of the trailer door TD, the carriage 134 translates along the drive support 120 such that the door arm 130 moves the door within the guide tracks 110 and 112. The pivotable couplings of the door arm 130 to the door bracket 132 and the carriage 134 allow a range of rotational motion of the door arm 130 as the uppermost door panel 111 of the trailer door TD transitions from the lower guide track portions 110a and 112a to the upper guide track portions 110b and 112b.

In some embodiments, the drive shaft 122 operably rotates about its longitudinal axis by rotational input from a suitable motor 140 (e.g., an electric motor; FIG. 1A), either directly by an in-line coupling, or indirectly by a driven gear train, gearbox, chain, drivebelt, and/or other system. In the illustrated embodiment, the motor 140 is positioned toward an end (e.g., a distal end toward the front of the trailer relative to the driving direction) of the drive support 120 and includes an output shaft operably coupled to the drive shaft 122 with an in-line coupling (e.g., where the rotational axis of the output shaft of the motor 140 is aligned with the longitudinal axis of the drive shaft 122). As the output shaft of the motor 140 rotates in a first direction, it rotates the drive shaft 122 in the first direction to translate the carriage 134 axially along the drive support 120 to move the trailer door TD from, e.g., the closed position to the open position. Similarly, when the output shaft of the motor 140 rotates in a second direction opposite the first direction, it rotates the drive shaft 122 in the second direction to translate the carriage 134 axially along the drive support 120 to move the trailer door TD from the open position to the closed position. In these embodiments, the drive support 120, drive shaft 122, the motor 140, and other components of the system 100 are shown mounted on only one of the first and second guide tracks 110 and 112, since a typical counter-balanced trailer door TD does not require a centrally mounted opener. Although not shown, in other embodiments, an output shaft of the motor 140 can be positioned at an angle (e.g., a right angle) relative to the drive shaft 122 and can be operably coupled to the drive shaft 122 by a bevel gear (e.g. a right-angle gearbox with intersecting axes bevel gears, etc.), and/or any other suitable system. In other embodiments, the system 100 may include secondary components (e.g., a second motor, carriage, drive shaft, drive support, etc.) operably coupled to the second guide track 112 for dual operation or redundancy.

The motor 140 can be electrically connected (via, e.g., a wired and/or wireless connection) to a controller 150 (e.g., a processor, programmable logic controller (PLC), and/or other suitable processing device that executes computer readable instructions stored on memory, etc.) positioned on the tractor and/or trailer. In some embodiments, the controller 150 can receive control signals (e.g. wireless and/or wired signals) from, e.g., an operator through a suitable user interface (e.g., a keypad, touchscreen, etc.) on the tractor and/or trailer, from a loading dock control system 160 (e.g., a processor, programmable logic controller (PLC), and/or other suitable processing device that executes computer readable instructions stored on memory, etc.), and/or from a loading dock operator through a suitable user interface (e.g., a keypad, touchscreen, etc.) at a loading dock control panel, at an Automated Guided Vehicle (AGV), etc. The control signals can be transmitted by direct electrical connection and/or wirelessly. In configurations where the control signal is wirelessly transmitted to the controller 150, an antenna 152 can be electrically connected to controller 150 for receiving the control signal from, e.g., a transmitter associated with the loading dock control system 160, a remote controller, a transmitter on the tractor, etc. In some embodiments, the controller 150 can transmit status of the trailer door TD position, faults of the system 100, battery level, or other suitable information related to the system 100 to the trailer, tractor, loading dock control system 160, AGV, etc. for, e.g., display to an operator, storage, etc. The controller 150 can be configured to require that the control signal be authenticated prior to the controller 150 operating the motor 140, e.g., by verifying an authentication level at the user interface after the user inputs a personal identification number (PIN), code, magnetic card, etc. The system 100 may also include a suitable power source 154 to operate the motor 140 and open/close the trailer door TD. In some embodiments, the power source 154 can include a battery positioned in a suitable location on the trailer (e.g., within or mounted to the surface of an interior wall or ceiling, under the floor, etc.). The battery can be charged by, e.g., the tractor power system, regenerative braking, solar, etc., and/or can be charged by a power connection at the loading dock (e.g., with an electrical contact patch or connector drawing power from the loading dock and positioned on, e.g., the trailer bar where it contacts the trailer restraint, etc.), as will be described below with reference to FIGS. 1C-1F.

FIGS. 1C and 1D are isometric and plan views, respectively, illustrating an embodiment of a power connection between a loading dock LD and a trailer T suitable for use with the system 100 and/or other trailer and/or tractor systems requiring electrical power. Referring to FIGS. 1C and 1D together, the trailer T can include a rear impact guard B, lights L, a first contact patch 161a, and a second contact patch 161b. In some embodiments, the first and second contact patches 161a and 161b are positioned on exterior surfaces of the trailer T and electrically coupled to the controller 150, antenna 152, and/or battery 154 (FIG. 1A). In the illustrated embodiment, the first and second contact patches 161a and 161b are positioned on aft portions of the side walls of the trailer T. In other embodiments, the contact patches 161a, 161b can be located in other positions on the exterior surfaces of the trailer T, the rear impact guard B, etc. In most embodiments, the contact patches 161a, 161b can be formed of conductive metal (e.g., ferrous metals, copper, etc.). The first contact patch 161a can be positive or negative polarity and the second contact patch 161b can be the other of positive or negative polarity from the first contact patch 161a. The loading dock LD can include first and second protrusions 162a and 162b (which could also be referred to as protruding members, extension members, etc.) that carry first and second loading dock contact patches 164a and 164b, respectively, corresponding respectively in position and polarity to the first and second contact patches 161a and 161b of the trailer T. In use, as a tractor/trailer backs up to the loading dock LD, the loading dock contact patches 164a and 164b contact and electrically couple with the contact patches 161a and 161b of the trailer T to provide, e.g., power to open/close the trailer door TD, charge the battery 154, energize the controller 150 and/or antenna 152, energize tractor systems/charge tractor batteries, etc. The contact patches 164a and 164b can provide power from a loading dock power source via a wired connection. In some embodiments, the protrusions 162a and 162b can be articulable and/or or flexible such that electrical coupling to the trailer T can be made when the trailer is not directly aligned with the dock centerline, at a skewed angle, etc. In embodiments with articulable protrusions 162a and 162b, the trailer can be parked and restrained prior to making the electrical connection to ensure the connection is not lost by movement of the trailer. Although referred to herein as “contact patches,” in some embodiments, the contact patches 161a, 161b, 164a and/or 164b can also be referred to as “contact plates,” “contact features,” and/or simply as “contacts.”

In some embodiments, the system 100 can be configured to operate in response to signals from the transmitter of the loading dock control system 160 (FIG. 1A) for actuation of the powered trailer door TD. For example, in some embodiments, the loading dock control system 160 can be configured to send and receive various signals related to status of the trailer door TD (e.g., open or closed, faults, battery level, etc.). The signals can be transmitted via wired or wireless connections and can be a portion of a loading dock workflow or sequence (e.g., an automated or manual sequence). In some embodiments, the system 100 can also be operable manually by a physical switch (e.g., a button or switch on the trailer, tractor, etc.). In some embodiments, the loading dock control system 160 can communicate with an AGV and/or forklift to verify the trailer door open/closed/fault status from the controller 150, and communicate such status to, e.g., the loading dock control system 160.

FIG. 1E is a plan view illustrating a power connection system configured in accordance with further embodiments of the present technology. In a similar manner to the contact patch embodiments described in reference to FIGS. 1C and 1D above, the embodiment in FIG. 1E is configured to provide power between a loading dock LD and a trailer T suitable for use with, e.g., the system 100. In the embodiment shown in FIG. 1E, a first flexible contact member 170a and a second flexible contact member 170b can be positioned at the loading dock LD and configured to contact and provide power through, e.g., the first and second contact patches 160a and 160b, respectively, shown in FIG. 1C. In other embodiments, the first and second flexible contact members 170a and 170b can be positioned to contact other contact patches on the trailer T, such as other contact patches positioned on the vertical sides of the cargo compartment, on the rear impact guard B, on surfaces above or below the trailer door TD, etc. The first and second flexible contact members 170a and 170b can be mounted to an exterior surface of the loading dock LD and made from a resilient material, e.g., metal, polymer, or the like and include at least a conductive portion for transferring power to the trailer T. The conductive portion can be formed of a conductive metal (e.g., ferrous metals, copper, etc.) and can provide power from a loading dock power source via a wired connection. The loading dock LD can further include a first grounding member 172a and a second grounding member 172b positioned to contact corresponding grounding contact patches 173a and 173b on the trailer T, e.g., grounding contact patches on the rear impact guard B (not shown), etc., and configured to provide a ground path (e.g., to the trailer ground connection to the tractor, or other suitable grounded component). The grounding members 172a and 172b and the contact patches 173a and 173b can be formed of a conductive metal (e.g., ferrous metals, copper, etc.). In some embodiments, the grounding members 172a and 172b can adjust in length (e.g., telescoping, collapsible, etc.) to correspond to a varying distance between the loading dock LD and the trailer T, and can be biased against the contact patches 173a and 173b to form a reliable electrical connection. for the power delivered by other components of the power connection system (e.g., the first and second flexible contact members 170a and 170b).

In some embodiments, the first flexible contact member 170a can be configured to provide a first type of power delivery having characteristics, e.g., (alternating or direct current), voltage, amperage, current protection threshold, etc. that differ from the characteristics of a second type of power delivery provided by the second flexible contact member 170b. In some embodiments, components of the system shown in FIG. 1E can be unpowered/unenergized when the trailer T is not present at the loading dock LD, and energized by the loading dock system 160 when, e.g., the trailer T is detected by a sensor (e.g., an optical sensor, electronic sensor, limit switch, pressure sensor, etc.) to be present at the loading dock, when a trailer restraint is engaged with the trailer T, by a manual control input by an operator via, e.g., a suitable user interface (e.g., a keypad, touchscreen, etc.), during a loading dock operation sequence, etc. In some embodiments, the flexible contact members 170a and 170b can deflect such that electrical coupling to the trailer T can be made when the trailer is not aligned with the dock centerline, positioned at a skewed angle (as shown in FIG. 1E), etc. The flexible contact members 170a and 170b can be made from plastic, rubber, or other resilient material, and/or can have joints, hinges, or other articulating portions, and can further include a conductive contact element attached to a side portion of the contact member facing the dock centerline.

By way of example, the first loading dock contact patch 164a and/or the first flexible member 170a can be configured to deliver alternating current (AC) power at 480V (or alternatively at 280V, 208V, 110V, etc.), which may be suitable for charging a hybrid-or electric-powered tractor, while the second loading dock contact patch 164b and/or second flexible member 170b can be configured to deliver direct current (DC) power at 24V (or alternatively at 12V, 6V, etc.), which may be suitable to power the system 100, charge the battery 154, energize the controller 150 and/or antenna 152, power one or more trailer sensors, etc. In this example, the first grounding member 172a can provide a ground path for the power delivered by the first flexible member 170a and the second grounding member 172b can provide a ground path for the power delivered by the second flexible member 170b. In embodiments in which the trailer T does not include an on-board battery, the power delivery by one of the first and second loading dock contact patches 164a and 164b and/or the first and second flexible members 170a and 170b can be configured to directly power various components of the trailer T, such as the system 100.

FIG. 1F is a rear view of a trailer T illustrating a power connection system configured in accordance with other embodiments of the present technology for providing power between a loading dock LD (FIGS. 1D and 1E) and the trailer T, and suitable for use with, e.g., the system 100 described above. In the embodiment shown in FIG. 1F, a first electrical connector 174a (e.g., a first electrical receptacle) and a second electrical connector 174b (e.g., a second electrical receptacle) can be positioned on the trailer T and configured to electrically couple to respective connectors (not shown) positioned on the loading dock LD. The first and second electrical connectors 174a and 174b can be configured with mounting systems allowing various degrees of freedom (e.g., lateral, rotational, etc.) for self-aligning with the respective connectors on the loading dock LD so that the respective connectors can be automatically connected as the trailer T backs up to the loading dock LD. For example, in some embodiments, the loading dock LD can include connectors mounted to the face of the loading dock LD at approximately the same positions (e.g., approximately the same vertical and lateral positions) as the corresponding first and second electrical connectors 174a and 174b are located on the trailer T. In some embodiments, the connectors on the loading dock LD can be stationary, or they can be guided by a guidance system (e.g., a sensor, a camera, etc.) at the loading dock LD. In other embodiments, the connectors at the loading dock LD can include an alignment feature (e.g., a ramp, a cone, one or more rollers, etc.) to engage a corresponding alignment feature on the trailer T and ensure reliable connection between the corresponding connectors when the trailer T backs up to the loading dock LD. In some embodiments, the first electrical connector 174a can be configured for a different type of power delivery (AC/DC), voltage, amperage, current protection threshold, and/or have other differing characteristic from the configuration of the second electrical receptacle 174b, similar to the embodiments of FIG. 1E described above. The power connection system embodiments described herein can have any combination of power delivery components, and can include any suitable combination of contact patches and/or connectors.

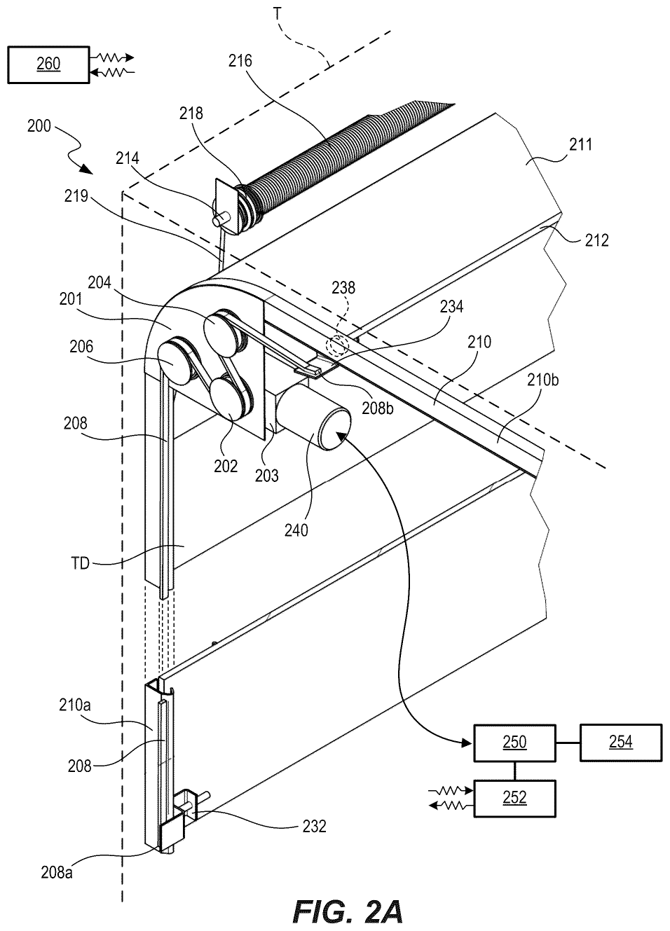

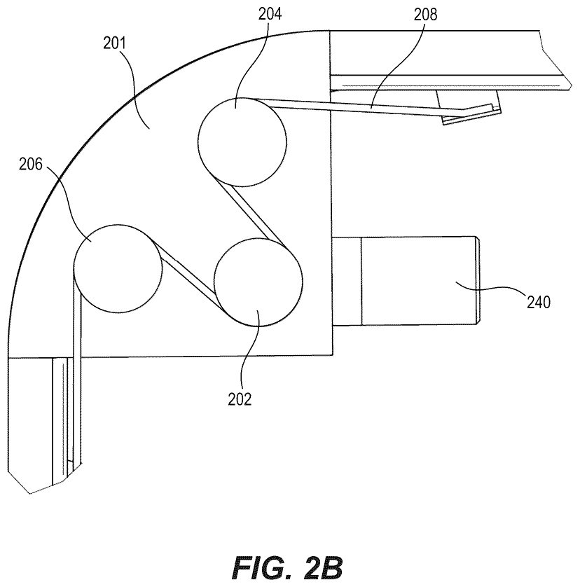

FIGS. 2A and 2B are isometric and side elevation views, respectively, illustrating an automated trailer door system 200 (“system 200”) configured in accordance with other embodiments of the present technology. The system 200 includes components associated with a trailer T that can automate the opening and/or closing of a trailer door TD, e.g., by a signal initiated by the driver, from an operator at a loading dock, from a loading dock control system, etc. (e.g., as described above with reference to the system 100 of FIG. 1A). The system 200 includes a guide track 210 with a lower guide track portion 210a in a generally vertical orientation for retaining the trailer door TD in the closed position, and an upper guide track portion 210b in a generally horizontal orientation for retaining the trailer door TD in the open position. In some embodiments, the upper track portion 210b supports the trailer door TD in a horizontal position so that the trailer door TD does not tend to move from the open position toward the closed position without actuation by the system 200 or manual input. Although only one guide track 210 is shown for purposes of illustration, it will be understood that the system 200 further includes a second guide track on the opposite side of the trailer door TD, which can be similar to or the same as the guide track 112 shown in FIG. 1A. The system 200 can further include a counterbalance system with a shaft 214, a spring 216, and a drum 218 with a cable 219 operably coupled to the trailer door TD to aid in the opening and/or closing force of the trailer door TD.

In some embodiments, the system 200 includes a mounting plate 201, a driven pulley/gear 202 operably coupled to an electric motor 240, a first idler pulley/gear 204, and a second idler pulley/gear 206. The output shaft (not shown) of the motor 240 can be positioned at a right angle to the rotational axis of the gear 202 and operably coupled to an axle of the pulley/gear 202 by means of a bevel gear (e.g. a right-angle gearbox 203 with intersecting axes bevel gears, etc.) or any other suitable system, such that rotation of the motor output shaft causes corresponding rotation of the pulley/gear 202. As shown in FIG. 2B, the motor 240 can be positioned in a horizontal orientation, a vertical orientation (not shown), or any other suitable orientation for performance, access, packaging, etc. The pulleys/gears 202, 204, and 206 are configured to interface with a flexible drive member 208 (e.g., a ribbed or toothed belt, poly belt, chain, cable, etc.), with the drive gear 202 rotating to drive the flexible drive member 208, and the idler pulleys/gears 204 and 206 interfacing with the flexible drive member 208 to change direction of the flexible drive member 208 and to ensure the flexible drive member 208 remains under suitable tension during operation. One or more of the pulleys/gears 202, 204, and 206 can be toothed to reduce slippage with respect to the flexible drive member 208. The flexible drive member 208 has a first end portion 208a that can be coupled to a lower portion of the trailer door TD by a first door bracket 232, and a second end portion 208b that can be coupled to an upper portion of the trailer door TD by a second door bracket 234. The second door bracket 234 can be attached to an end portion of a crossover member 212, and an upper roller 238 can be rotatably coupled to the end portion of the crossover member 212 for travelling within the guide track 210. The crossover member 212 is configured to provide support for the upper roller 238 as the trailer door TD moves between the open and closed positions. The second door bracket 234 may be positioned separated from the uppermost panel 211 of the trailer door TD so that the second door bracket 234 does not interfere with the mounting plate 201 or the first idler pulley/gear 204 and the upper roller 238 is positioned within the upper guide track portion 210b when the trailer door TD is in the closed position.

In a similar manner to the system 100 described above, the motor 240 of the system 200 can be controlled by a controller 250 (e.g., a processor, PLC, or other suitable processing device that executes computer readable instructions, etc.) that receives a control signal from e.g., an operator through a user interface on the tractor and/or trailer, a loading dock control system, and/or a loading dock operator through a user interface at the loading dock or an AGV, etc. In this regard, the controller 250 can include an antenna 252 for receiving a wireless signal from a transmitter 260, e.g., on the loading dock control system, a remote controller, etc. and transmitting status of the trailer door TD position, faults of the system 200, battery level, or other suitable information related to the system 200 to the trailer, tractor, loading dock control system 260, AGV, etc. The controller 250 can be configured to require that the control signal be authenticated prior to the controller 250 controlling the motor 240, e.g., by verifying an authentication level at the user interface after the user inputs a PIN, code, magnetic card, etc. The system 200 may also include a suitable power source 254 to operate the motor 240 and open/close the trailer door TD. In some embodiments, the power source 254 can include a battery positioned in a suitable location on the trailer that can be charged by the tractor power system, regenerative braking, solar, etc., or can be charged by a power connection at the loading dock (e.g., with a contact patch drawing power from the loading dock, such as the system described above with respect to FIGS. 1C-1F, on the trailer bar interfacing the trailer restraint, etc.). In some embodiments, the system 200 can be configured to operate in response to signals from the loading dock control system 260 for actuation of the trailer door TD. In such embodiments, the control system can be configured to send and receive various signals related to status of the trailer door TD (e.g., open or closed, faults, battery level, etc.). The signals can be transmitted via wired or wireless connections, and may be a portion of a loading dock workflow or sequence (automated or manual). In some embodiments, the system 200 may also be operable manually by a physical switch (e.g., a button or switch on the trailer, tractor, etc.). In some embodiments, the loading dock control system 260 can communicate with an AGV and/or forklift to verify trailer door open/closed/fault status from the controller 250 and communicate such status to the loading dock control system 260.

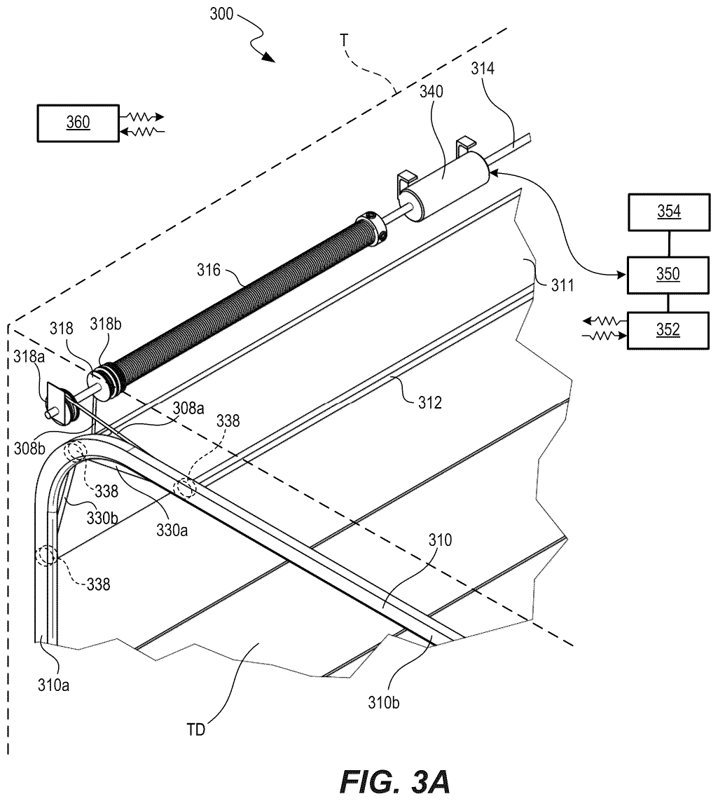

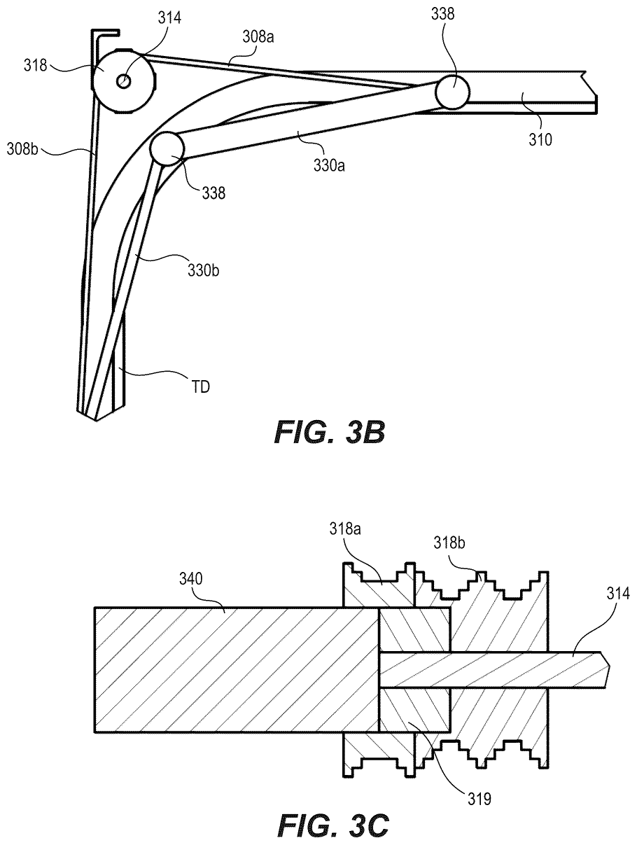

FIGS. 3A-3C are isometric, side elevation, and detail cross-sectional views, respectively, illustrating an automated trailer door system 300 (“system 300”) configured in accordance with other embodiments of the present technology. FIG. 3A shows a motor location central to the counterbalance system and FIG. 3C shows a motor location partially inside a drum assembly, as will be described below. The system 300 includes components associated with a trailer that can automate the opening and/or closing of a trailer door TD, e.g., by a signal initiated by the driver, from an operator at a loading dock, from a loading dock control system, etc. The system 300 includes a guide track 310 with a lower guide track portion 310a in a generally vertical orientation for retaining the sides of the trailer door TD in the closed position, and an upper guide track portion 310b in a generally horizontal orientation for retaining the sides of the trailer door TD in the open position. In some embodiments, the upper track portions 310b supports the trailer door TD in a horizontal position so that the trailer door TD does not tend to move from the open position toward the closed position without actuation by the system 300 or manual input. Although only one guide track 310 is shown for purposes of illustration, it will be understood that the system 300 further includes a second guide track on the opposite side of the trailer door TD, which can be similar to or the same as the guide track 112 shown in FIG. 1A. The system 300 can include first and second door arms 330a and 330b, respectively, each rotatably coupled to rollers 338 on each end, with the rollers 338 configured to travel within the guide track 310. In some embodiments, at least some of the rollers 338 coupled to the first door arm 330a can be supported by a crossover tube 312 positioned away from the top panel of the trailer door TD. The rollers 338 can be positioned away from the uppermost panel 311 of the trailer door TD so that the upper roller 338 is within the upper guide track portion 310b when the trailer door TD is in the closed position.

The system 300 further includes a counterbalance system with a shaft 314, a spring 316, a drum assembly 318, and first and second cables 308a and 308b to aid in the opening and/or closing force of the trailer door TD. The shaft 314 can include a through-shaft motor 340 (e.g., an electric motor) positioned at an intermediate axial position (or at other axial positions) along the shaft 314 and configured to rotate the shaft 314 to open and close the trailer door. The through-shaft motor 340 provides rotation to the drum assembly 318, having a first drum portion 318a operably associated with the first cable 308a, and a second drum portion 318b operably associated with the second cable 308b. More specifically, in some embodiments the first cable 308a can be wound about the first drum portion 318a, coupled to the first door arm 330a, and configured to move the trailer door TD from the open position to the closed position when pulled in tension by operation of the motor 340. The second cable 308b can be wound about the second drum portion 318b, coupled to a lower portion of the trailer door TD, and configured to move the trailer door TD from the closed position to the open position when pulled in tension by operation of the motor 340. The first and second drum portions 318a and 318b may include a clutch system 319 (e.g., a sprag clutch, see FIG. 3C, showing another embodiment of the position of the through-shaft motor 340), to neutralize any differential length in the cables 308a and 308b as the trailer door TD moves between the open and closed positions. In use, as the first cable 308a is wound onto the first drum portion 318a, pulling on the first door arm 330a to close the door, the second cable 308b is payed out from the second drum portion 318b and extends along the lower guide track portion 310a with the lower portion of the trailer door TD. Alternatively, as the second cable 308b is wound onto the second drum portion 318b, pulling on the lower portion of the trailer door TD to open the door, the first cable 308a is payed out from the first drum portion 318a and extends with the first door arm 330a along the upper guide track portion 310b.

In a similar manner to the systems 100 and 200 described above, the motor 340 of the system 300 can be controlled by a controller 350 (e.g., a processor (PLC) or other suitable processing device, such as a processor/chip that executes computer readable instructions, etc.) that receives a control signal from the trailer, tractor, loading dock, AGV, manual switch, etc. In this regard, the controller 350 can include an antenna 352 for receiving a wireless signal from a loading dock control system 360 and transmitting status of the trailer door TD position, faults of the system 300, battery level, or other suitable information related to the system 300 to the trailer, tractor, loading dock control system 360, AGV, etc. The controller 350 can be configured to require that the control signal be authenticated prior to the controller 350 controlling the motor 340, e.g., by verifying an authentication level at the user interface after the user inputs a PIN, code, magnetic card, etc. As shown in FIG. 3C, in other embodiments, the motor 340 can be positioned near or partially inside the first and second drum portions 318a and 318b and can include a clutch system 319 (e.g., a friction clutch, centrifugal clutch, electric clutch, etc.) that selectively transfers rotation from the motor to one or both of the drum portions 318a and 318b.

The system 300 may also include suitable power source 354 to operate the motor 340 and open/close the trailer door TD. In some embodiments, the power source 354 can include a battery positioned in a suitable location on the trailer that can be charged by the tractor power system, regenerative braking, solar, etc., or can be charged by a power connection at the loading dock (e.g., with a contact patch drawing power from the loading dock, such as the system described above with respect to FIGS. 1C-1F, on the trailer bar interfacing the trailer restraint, by wireless charging via electromagnetic induction, etc.). In some embodiments, the system 300 can be configured to operate in response to signals from the loading dock control system 360 for actuation of the automated powered trailer door. In such embodiments, the control system can be configured to send and receive various signals related to status of the trailer door TD (e.g., open or closed, faults, etc.). The signals can be transmitted via wired or wireless connections, and may be a portion of a loading dock workflow or sequence (automated or manual). In some embodiments, he system 300 may also be operable manually by a physical switch (e.g., a button on the trailer, tractor, etc.). In some embodiments, the loading dock control system 360 can communicate with an AGV and/or forklift to verify trailer door open/closed/fault status from the controller 350 and communicate such status to the loading dock control system 360.

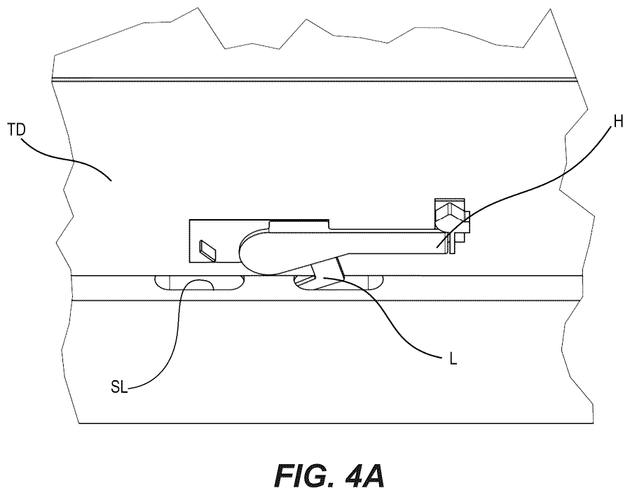

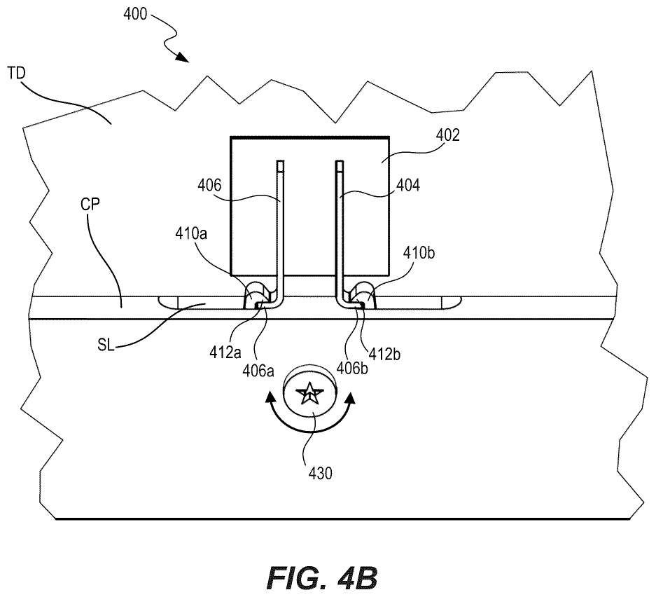

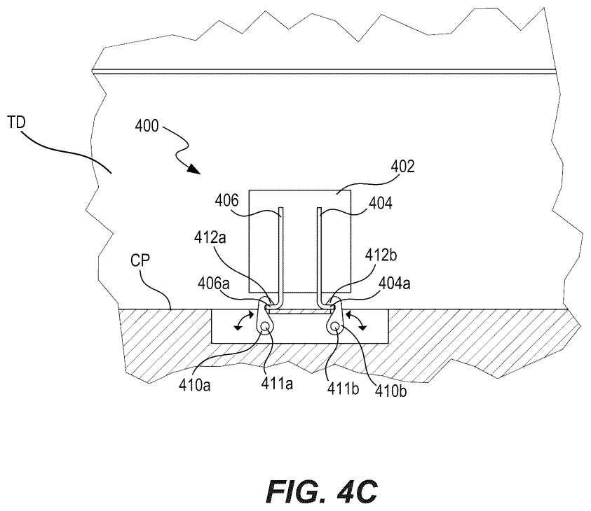

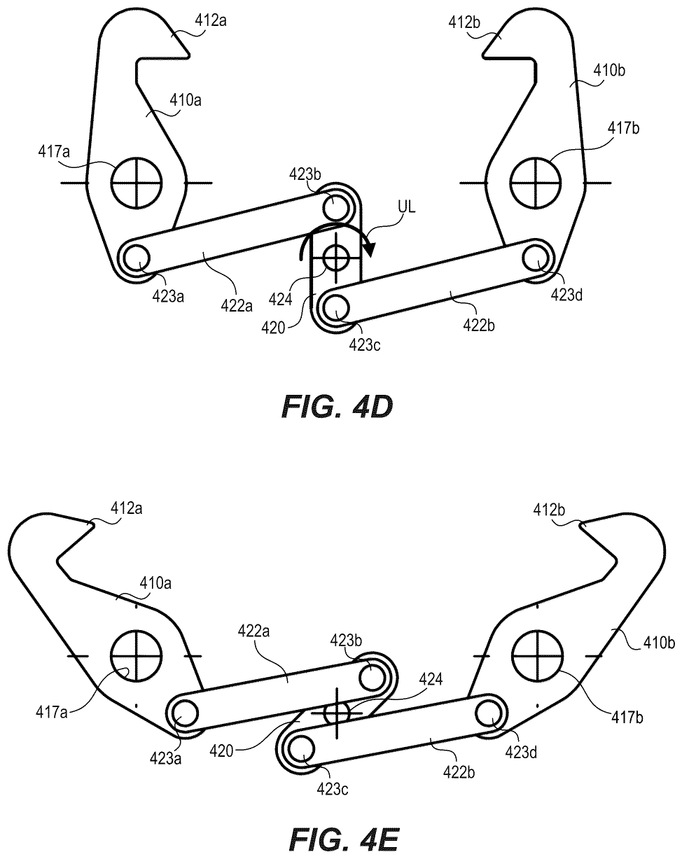

FIG. 4A illustrates a conventional latch system for use with a trailer door TD, the system having a handle H for manually actuating a latch L, and slots SL for receiving a hook portion of the latch L to prevent opening of the trailer door TD. FIGS. 4B-4E illustrate an automated trailer door latch system 400 (“system 400”) configured in accordance with embodiments of the present technology. Components of the system 400 can be retrofitted to existing trailer doors and/or trailers or can be installed on newly manufactured trailer doors and/or trailers. Referring to FIG. 4B, the system 400 includes a striker plate 402 having a first flange 404 with a first locking portion 404a and a second flange 406 with a second locking portion 406a. The first and second locking portions 404a and 406a can be configured for positioning adjacent the slots SL when the trailer door TD is in the closed position. The striker plate and flanges 404 and 406 are movable with the trailer door TD during opening and closing.

Referring to FIGS. 4B and 4C together, the system 400 further includes a first rotatable locking arm 410a and a second rotatable locking arm 410b, configured to rotate (e.g., simultaneously) in opposite directions from each other about corresponding pivot shafts 411a and 411b. The rotatable locking arms 410a and 410b are positioned such that corresponding hook portions 412a and 412b can be selectively rotated from a stowed position below (or at least partially below) the lateral surface of the catch plate CP, to a deployed position as shown in FIG. 4B, extending through the slots SL in the catch plate CP and engaging the locking portions 404a and 406a, respectively, of the flanges 404 and 406 to secure the trailer door TD in the closed position. The locking arms 410a and 410b can be rotated individually or in unison by any suitable system, such as by a motorized system, to automate securement of the trailer door TD. For example, as shown in FIG. 4B, an interface feature 430 (e.g., a socket, hex, slot, etc.) can be operably coupled to either or both of the locking arms 410a and 410b and positioned in a component (e.g., a surface of the bumper, floor, etc.) of the trailer T such that rotation of the interface feature 430 can engage and disengage the system 400 to externally lock and unlock the trailer door TD. These embodiments can be used with an external drive interface (such as a ratchet, driver, or automated rotational system) for locking/unlocking the trailer door TD.

As shown in FIG. 4D and 4E, for example, the locking arms 410a and 410b are linked to a bell crank 420 via a first link 422a having pins 423a and 423b and a second link 422b having pins 423c and 423d. In this embodiment, the bell crank 420 is an over-center link, which rotates the locking arms 410a and 410b in opposite directions about their corresponding pivot shafts 417a and 417b as the bell crank 420 is rotated about its pivot shaft 424 (e.g., by the interface feature 430 operably coupled to the bell crank 420). In the locked configuration shown in FIG. 4D, the bell crank 420 can be rotated in a clockwise direction of arrow UL to the unlocked configuration shown in FIG. 4E. In some embodiments, the bell crank 420 and/or the locking arms 410a and 410b are rotated by one or more motors (not shown) positioned on the trailer and operably coupled to the corresponding pivot shafts 417a and 417b, e.g., by a signal from the loading dock, the tractor/trailer/truck driver, a manual signal by another operator, etc. In some embodiments, only a single rotatable locking arm is used with the system 400.

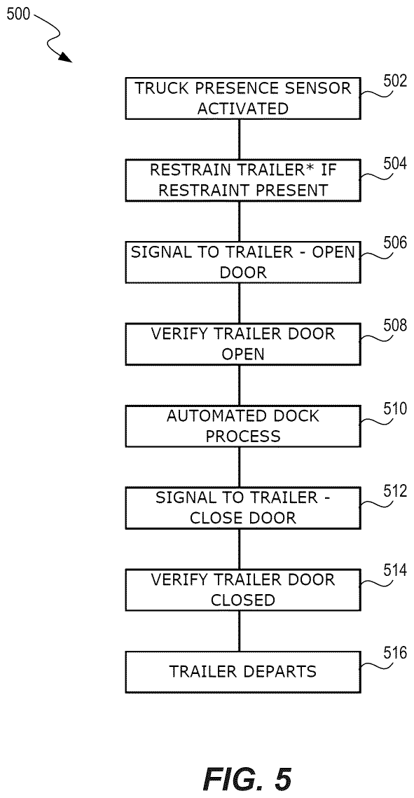

FIGS. 5-7 show representative loading dock operational flowcharts 500, 600, and 700, respectively, for use with the systems 100-400 described above in accordance with embodiments of the present technology. Turning first to FIG. 5, the flowchart 500 begins in block 502 when a truck presence sensor (e.g., a pressure sensor, optical sensor, etc.) senses the presence of a truck at a loading dock. The truck presence sensor can be positioned on the parking surface in front of the loading dock, on a loading dock door, a wall of the loading dock, or any other suitable surface. In response to detecting the presence of a trailer by the truck presence sensor, the loading dock control system, (e.g. the loading dock control system 160, 260 or 360 described above), can send a signal to initiate operation of a trailer restraint in block 504 if a restraint is present. The trailer restraint can be any suitable restraint for preventing movement of the trailer during loading/unloading. Next, in block 506, the loading dock control system sends a signal to a controller on the trailer (e.g., the controller 150, 250 or 350 described above) to open the trailer door using any of the systems 100, 200, and/or 300. In trailers having the system 400, the loading dock control system may first send a signal to unlock the trailer door prior to opening the trailer door. The signal can be a wireless signal, or can be a wired signal through contacts on the trailer. Next, and block 508, the loading dock control system verifies that the trailer door is open, e.g., by visual confirmation, a signal from the controller on the trailer, a signal from a door sensor, a signal from an AGV, etc. Once the loading dock control system verifies that the trailer door is open, in block 510, an automated dock process may be initiated (e.g., turning on one or more lights, deploying a door seal, leveling the dock, loading/unloading the trailer, etc.). After the automated dock process concludes (as indicated by, e.g., input to the control system from an operator), in block 512, the loading dock control system can send a signal to the controller on the trailer to close the trailer door. Next, in block 514, the loading dock control system verifies that the trailer door is closed, e.g., by visual confirmation, a signal from the controller on the trailer, a signal from a door sensor, a signal from an AGV, etc. Next, in block 516, the trailer restraint may be released such that the trailer can depart.

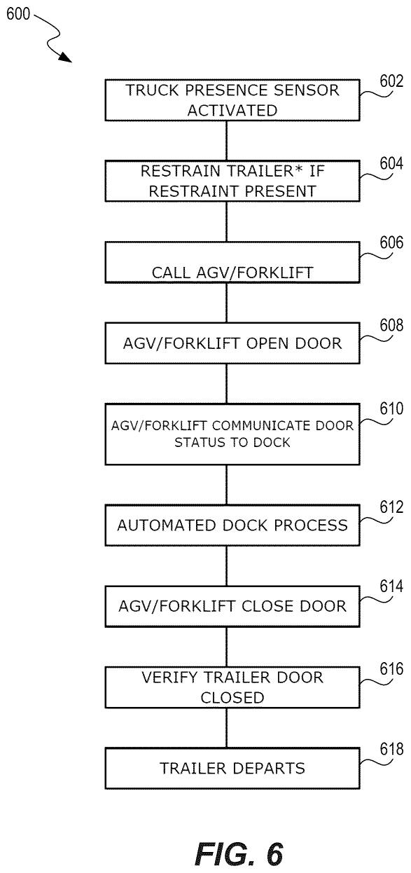

FIG. 6 shows a loading dock operation flowchart 600 including operations of the powered trailer door systems 100-400 described herein. The flowchart 600 begins in block 602 when a truck presence sensor senses the presence of a truck at a loading dock. The truck presence sensor can be positioned on a loading dock door, a wall of the loading dock, or any other suitable surface. The presence of a trailer detected by the truck presence sensor can cause the loading dock control system to initiate engagement of a trailer restraint in block 604, if a trailer restraint is present. The trailer restraint can be any suitable restraint for preventing movement of the trailer during loading/unloading. Next, in block 606, the loading dock control system, e.g. as described above, sends a signal (e.g., a wireless signal) to call an AGV, and then in block 608, sends a signal to the AGV that causes the AGV to send a signal (e.g., a wireless signal) to the trailer to open the trailer door using any of the systems 100, 200 and/or 300. In trailers having the system 400, the AGV may first send a signal to unlock the trailer door prior to opening the trailer door. The signal can be wireless, or can be a wired signal through contacts on the trailer. Next, and block 610, the AGV verifies that the trailer door is open, e.g., by visual confirmation, a signal from the controller on the trailer, etc. and communicates the door status to the loading dock control system. Once the loading dock control system verifies that the trailer door is open, in block 612, an automated dock process may be initiated (e.g., turning on one or more lights, deploying a door seal, leveling the dock, etc.). After the automated dock process concludes, in block 614, the AGV can send a signal (e.g., a wireless signal) to the controller on the trailer to close the trailer door. Next, in block 616, the loading dock control system verifies that the trailer door is closed, e.g., by visual confirmation, a signal from the controller on the trailer, an AGV, etc. Next, in block 618, the trailer restraint may be released such that the trailer can depart.

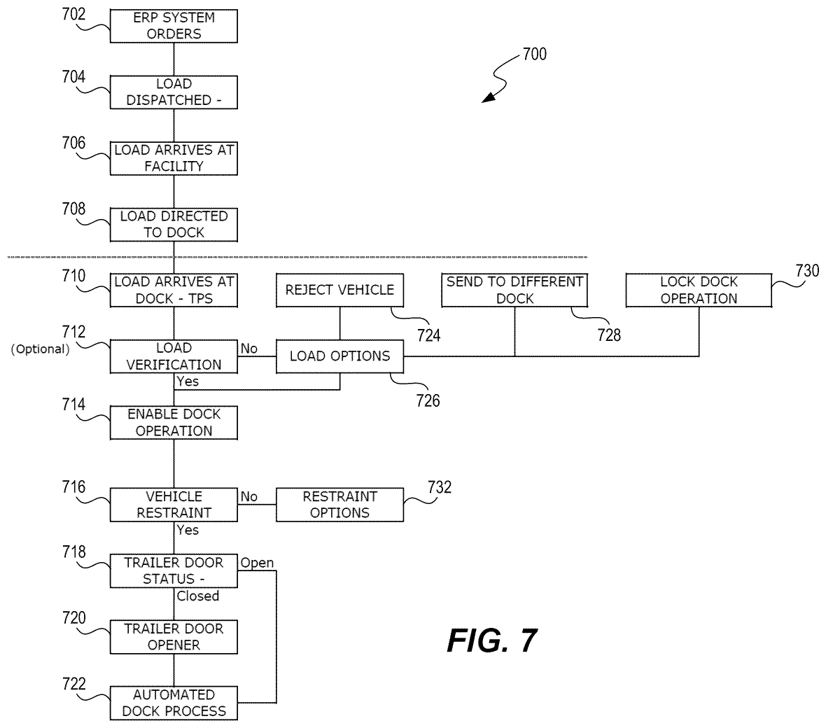

FIG. 7 shows a loading dock operation flowchart 700 including operations of the powered trailer door systems 100-400 described herein, where an identification system, such as the systems described in U.S. Provisional App. No. 63/284,501, filed Nov. 30, 2021, and titled TRAILER VALIDATION SYSTEMS, which is incorporated by reference herein in its entirety, can be used with the flowchart 700. The flowchart 700 begins in block 702 where an Enterprise Resource Planning (ERP) system orders items delivered by a trailer. Next, in block 704, the load is dispatched and in block 706, the load arrives at the facility. In block 708, the load is directed to a loading dock and in block 710 the load arrives at the loading dock. Next, in optional block 712, the load is verified, e.g., by any suitable load verification signal, including the identification system incorporated by reference herein. If the load is unverified, in block 726, the loading dock control system selects load options, including rejecting the vehicle at block 724, sending the vehicle to a different dock at block 728, and locking operation of the loading dock at block 730. Alternatively, if the load is verified, in block 714, the loading dock operation is enabled. Next, in block 716, a vehicle restraint can be applied to the trailer to prevent movement of the trailer during loading/unloading. If the vehicle restraint is not present, in block 732, restraint options can be available to the loading dock control system, e.g., wheel chocks, manual restraint, etc. Once the restraint is verified, the loading dock control system queries the trailer door status in block 718, e.g., whether the trailer door is open or closed, by visual confirmation, a signal from the controller on the trailer, an AGV, etc. If the trailer door is closed, the loading dock control system sends a signal to the trailer in block 720, using any method described above, to open the trailer door using any of systems 100-400 described herein. If the trailer door is open at the query in status of block 718, or after opening in block 720, the automated dock process is initiated in block 722. Although not shown, the flowchart 700 may further include sending a signal to close the trailer door and releasing the trailer restraint so that the trailer can depart from the loading dock.

### Selected Examples

1. A powered trailer door operating system for use with a trailer door, comprising:
   a guide track having a lower guide track portion configured to position the trailer door at a closed position and an upper guide track portion configured to position the trailer door at an open position;
   a drive support coupled to the upper guide track portion, the drive support having a central cavity and a slot extending through the drive support into the central cavity, the slot positioned longitudinally along at least a portion of the drive support;
   a drive shaft positioned within the central cavity; and
   a carriage slidingly coupled to the drive support and operably coupled to the trailer door, wherein the carriage is operably engaged with the drive shaft through the slot such that rotation of the drive shaft causes the carriage to translate along the drive support, thereby moving the trailer door between the closed position and the open position.
2. The powered trailer door operating system of claim 1, wherein the drive shaft comprises helical screw-type threads, and wherein the carriage further comprises an engagement member having teeth configured to operably engage the helical screw-type threads.
3. The powered trailer door operating system of claim 1, further comprising a door arm pivotably coupled between the carriage and the trailer door.
4. The powered trailer door operating system of claim 1, wherein the drive support includes a semi-circular wall portion at least partially surrounding the central cavity, and wherein the carriage has an engagement portion configured to slidingly contact the semi-circular wall portion of the drive support.
5. The powered trailer door operating system of claim 1, further comprising a motor configured to rotate the drive shaft.
6. The powered trailer door operating system of claim 5, wherein the motor is an in-line motor.
7. The powered trailer door operating system of claim 5, wherein the motor has an output shaft positioned at an angle relative to the drive shaft, and wherein the motor engages the drive shaft by means of a bevel gear.
8. The powered trailer door operating system of claim 5, further comprising a controller for controlling the motor, wherein the controller is configured to receive a signal from:
   an operator via a user interface on a tractor and/or a trailer,
   a loading dock control system,
   a loading dock operator via a user interface at the loading dock, or
   an Automated Guided Vehicle (AGV), and
   wherein the controller is further configured to execute computer readable instructions that cause the trailer door to move between the closed and open positions in response to the signal.
9. The powered trailer door operating system of claim 8, wherein:
   the powered trailer door operating system is operably coupled to the trailer;
   the trailer comprises a first trailer contact patch and a second trailer contact patch positioned on an external surface of the trailer and electrically coupled to the controller;
   the first trailer contact patch has a positive polarity and is configured to contact a positive polarity loading dock contact patch when the trailer is positioned at the loading dock; and
   the second trailer contact patch has a negative polarity and is configured to contact a negative polarity loading dock contact patch when the trailer is positioned at the loading dock.
10. The powered trailer door operating system of claim 9, wherein the positive and negative polarity loading dock contact patches are configured to provide electrical power to the motor for moving the trailer door between the closed and open positions.
11. The powered trailer door operating system of claim 9, wherein the positive and negative polarity loading dock contact patches include flexible portions configured to maintain contact with the first and second trailer contact patches when the trailer is positioned proximate the loading dock and/or when the trailer is laterally misaligned with the loading dock.
12. The powered trailer door operating system of claim 9, wherein the trailer further comprises a grounding contact patch configured to contact a grounding member of the loading dock.
13. A powered trailer door operating system for use with a trailer door, comprising:
   a guide track having a lower guide track portion configured to position the trailer door at a closed position and an upper guide track portion configured to position the trailer door at an open position;
   a driven pulley coupled to the guide track; and
   a flexible drive member operably engaged with the driven pulley, the flexible drive member having a first end portion coupled to a lower portion of the trailer door and a second end portion coupled to an upper portion of the trailer door,
   wherein rotation of the driven pulley translates the flexible drive member to move the trailer door between the closed position and the open position.
14. The powered trailer door operating system of claim 13, further comprising:
   a mounting plate positioned between the driven pulley and the guide track;
   a first idler pulley coupled to the mounting plate and positioned to operably interact with the flexible drive member between the driven pulley and the first end portion; and
   a second idler pulley coupled to the mounting plate and positioned to operably interact with the flexible drive member between the driven pulley and the second end portion.
15. The powered trailer door operating system of claim 13, further comprising a crossover member having an upper roller operably engaged with the guide track, and wherein the second end portion is coupled to the upper portion of the trailer door via the crossover member.
16. The powered trailer door operating system of claim 13, further comprising a motor operably coupled to the driven pulley and configured to rotate the driven pulley to translate the flexible drive member.
17. The powered trailer door operating system of claim 16, further comprising a controller for controlling the motor, wherein the controller is configured to receive a signal from:
   an operator via a user interface on a tractor and/or a trailer,
   a loading dock control system,
   a loading dock operator via a user interface at the loading dock, or
   an Automated Guided Vehicle (AGV), and
   wherein the controller is further configured to execute computer readable instructions that cause the trailer door to move between the closed and open positions in response to the signal.
18. The powered trailer door operating system of claim 17, wherein:
   the powered trailer door operating system is operably coupled to the trailer;
   the trailer comprises a first trailer contact patch and a second trailer contact patch positioned on an external surface of the trailer and electrically coupled to the controller;
   the first trailer contact patch has a positive polarity and is configured to contact a positive polarity loading dock contact patch when the trailer is positioned at the loading dock; and
   the second trailer contact patch has a negative polarity and is configured to contact a negative polarity loading dock contact patch when the trailer is positioned at the loading dock.
19. A powered trailer door operating system for use with a trailer door, comprising:
   a guide track having a lower guide track portion configured to position the trailer door at a closed position and an upper guide track portion configured to position the trailer door at an open position;
   a counterbalance shaft having a first drum and a second drum;
   a first cable having a first end portion coupled to a lower portion of the trailer door and a second end portion operably engaging the first drum;
   a second cable having a first end portion coupled to an upper portion of the trailer door and a second end portion operably engaging the second drum; and
   a motor configured to rotate the counterbalance shaft,
   wherein rotation of the counterbalance shaft by means of the motor causes the first and second drums to rotate and translate the first and second cables, respectively, to move the trailer door between the closed position and the open position.
20. The powered trailer door operating system of claim 19, wherein the motor is positioned at an intermediate axial position along the counterbalance shaft or positioned at an end of the counterbalance shaft.
21. The powered trailer door operating system of claim 19, further comprising a crossover member having an upper roller operably engaged with the guide track, and wherein the second end portions of the first and second cables are coupled to the upper portion of the trailer door via the crossover member.
22. The powered trailer door operating system of claim 19, further comprising a first door arm positioned between the trailer door and the second end portion of the first cable and a second door arm positioned between the trailer door and the second end portion of the second cable, wherein the first and second door arms respectively couple the first and second cables to the upper portion of the trailer door.
23. The powered trailer door operating system of claim 19, further comprising a controller for controlling the motor, wherein the controller is configured to receive a signal from:
   an operator via a user interface on a tractor and/or a trailer,
   a loading dock control system,
   a loading dock operator via a user interface at the loading dock, or
   an Automated Guided Vehicle (AGV), and
   wherein the controller is further configured to execute computer readable instructions that cause the trailer door to move between the closed and open positions in response to the signal.
24. The powered trailer door operating system of claim 23, wherein:
   the powered trailer door operating system is operably coupled to the trailer;
   the trailer comprises a first trailer contact patch and a second trailer contact patch positioned on an external surface of the trailer and electrically coupled to the controller;
   the first trailer contact patch has a positive polarity and is configured to contact a positive polarity loading dock contact patch when the trailer is positioned at the loading dock; and
   the second trailer contact patch has a negative polarity and is configured to contact a negative polarity loading dock contact patch when the trailer is positioned at the loading dock.
25. An automated latch system for use with a trailer, the trailer having a trailer door and a catch plate separate from the trailer door, the automated latch system comprising:
   a striker plate configured to be mounted to the trailer door and having a first flange with a first locking portion and a second flange with a second locking portion, the first and second locking portions configured to be positioned adjacent to the catch plate when the trailer door is in a closed position;
   a first locking arm rotatable from a stowed position below the catch plate to a deployed position extending above the catch plate to engage the first locking portion when the trailer door is in a closed position;
   a second locking arm rotatable from a stowed position below the catch plate to a deployed position extending above the catch plate to engage the second locking portion when the trailer door is in a closed position; and
   wherein the first locking arm rotates from the stowed position toward the deployed position in a first direction and the second locking arm rotates from the stowed position toward the deployed position in a second direction opposite to the first direction.
26. The automated latch system of claim 25, further comprising a bell crank coupled to the first locking arm by a first link and to the second locking arm by a second link, wherein rotation of the bell crank causes rotation of the first and second locking arms in opposite directions.
27. The automated latch system of claim 25, further comprising a motor operably coupled to one or both of the first and second locking arms and configured to rotate the first and second locking arms between the deployed position and the stowed position.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, for fluid (e.g., air) transfer, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims. From the foregoing, it will be appreciated that specific embodiments of the invention have been described herein for purposes of illustration, but that various modifications may be made without deviating from the spirit and scope of the various embodiments of the invention. Accordingly, the invention is not limited, except as by the appended claims.

Any patents and applications and other references noted above, including any that may be listed in accompanying filing papers, are incorporated herein by reference in the entirety, except for any subject matter disclaimers or disavowals, and except to the extent that the incorporated material is inconsistent with the express disclosure herein, in which case the language in this disclosure controls. Aspects of the invention can be modified, if necessary, to employ the systems, functions, and concepts of the various references described above to provide yet further implementations of the invention.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

We claim:

1. A powered trailer door operating system for use with a trailer door of a trailer, comprising:
a motor operably coupled to the trailer door and configured to move the trailer door between a closed position and an open position;
a first trailer contact feature positioned on an exterior surface of the trailer, wherein the first trailer contact feature is operably connected to the motor; and
a second trailer contact feature positioned on the exterior surface of the trailer, wherein the second trailer contact feature is spaced apart from the first trailer contact feature, wherein the second trailer contact feature is operably connected to the motor, and wherein—
as the trailer backs up to a loading dock, the first trailer contact feature is configured to contact and electrically couple to a first station contact feature of the loading dock and the second trailer contact feature is configured to contact and electrically couple to a second station contact feature of the loading dock, whereby the first trailer contact feature and the second trailer contact feature collectively receive electrical power from an external power source via contact with the first station contact feature and the second station contact feature to drive the motor to move the trailer door between the closed position and the open position.

2. The powered trailer door operating system of claim 1 wherein the first trailer contact feature is positioned on an aft portion of the trailer, and wherein the second trailer contact feature is positioned on the aft portion of the trailer.

3. The powered trailer door operating system of claim 1 wherein the first trailer contact feature is positioned on a first side wall of the trailer, and wherein the second trailer contact feature is positioned on a second side wall of the trailer opposite to the first side wall.

4. The powered trailer door operating system of claim 1 wherein the first trailer contact feature is positioned on an aft portion of a first side wall of the trailer, and wherein the second trailer contact feature is positioned on an aft portion of a second side wall of the trailer opposite to the first side wall.

5. The powered trailer door operating system of claim 1 wherein the first trailer contact feature is positioned on a reward-facing portion of the trailer, and wherein the second trailer contact feature is positioned on the reward-facing portion of the trailer.

6. The powered trailer door operating system of claim 1 wherein the first station contact feature is mounted to a portion of the loading dock, wherein the second station contact feature is mounted to the portion of the loading dock, and wherein the first trailer contact feature and the second trailer contact feature collectively receive the electrical power from the external power source via contact with the first station contact feature and the second station contact feature when the trailer is parked at the loading dock.

7. The powered trailer door operating system of claim 1 wherein the first station contact feature is mounted to a face of the loading dock on a first side of a loading dock door of the loading dock, wherein the second station contact feature is mounted to the face of the loading dock on a second side of the loading dock door of the loading dock, wherein the second side is opposite to the first side, and wherein the first trailer contact feature and the second trailer contact feature collectively receive the electrical power from the external power source via contact with the first station contact feature and the second station contact feature when the trailer is parked at the loading dock.

8. The powered trailer door operating system of claim 1, further comprising a trailer grounding contact feature positioned on the exterior surface of the trailer, wherein as the trailer backs up to the loading dock, the trailer grounding contact feature is configured to contact and electrically couple to a station grounding contact feature of the loading dock to provide an electrical grounding path.

9. The powered trailer door operating system of claim 8 wherein the trailer grounding contact feature is positioned on a rearward-facing impact guard of the trailer.

10. The powered trailer door operating system of claim 1 wherein the first trailer contact feature has a positive polarity, wherein the second trailer contact feature has a negative polarity, wherein the first station contact feature has a positive polarity, and wherein the second station contact feature has a negative polarity.

11. A loading dock station, comprising:
a loading dock door;
an exterior surface configured to face a trailer;
a first station contact feature positioned on the exterior surface, wherein the first station contact feature is electrically coupled to a first power source; and
a second station contact feature positioned on the exterior surface and spaced apart from the first station contact feature, wherein the second station contact feature is electrically coupled to a second power source, and wherein—
as the trailer backs up toward the exterior surface, the first station contact feature is configured to contact and electrically couple to a first trailer contact feature of the trailer and the second station contact feature is configured to contact and electrically couple to a second trailer contact feature of the trailer, whereby the first station contact feature and/or the second station contact feature deliver electrical power from the first power source and/or the second power source to the trailer via contact with the first trailer contact feature and/or the second trailer contact feature to electrically power a system of the trailer.

12. The loading dock station of claim 11 wherein the first power source and the second power source comprise a same power source, and wherein the first station contact feature and the second station contact feature collectively deliver electrical power from the same power source to the trailer via contact with the first trailer contact feature and the second trailer contact feature to electrically power the system of the trailer.

13. The loading dock station of claim 11 wherein the first power source comprises an alternating current (AC) power source, and wherein the second power source comprises a direct current (DC) power source.

14. The loading dock station of claim 11 wherein the system of the trailer comprises at least one of a motor operably coupled to a trailer door of the trailer and configured to move the trailer door between a closed position and an open position, a battery, a controller, an antenna, and a sensor.

15. The loading dock station of claim 11 wherein the first station contact feature is resiliently mounted to the exterior surface, and wherein the second station contact feature is resiliently mounted to the exterior surface.

16. The loading dock station of claim 11 wherein the first station contact feature is mounted to the exterior surface via a first articulating member, and wherein the second station contact feature is mounted to the exterior surface via a second articulating member.

17. The loading dock station of claim 11 wherein the first station contact feature is positioned on the exterior surface on a first side adjacent to the loading dock door, and wherein the second station contact feature is positioned on the exterior surface on a second side adjacent to the loading dock door opposite to the first side.

18. A powered trailer system for use with a trailer, comprising:
an electrical system;
a first trailer contact feature positioned on an exterior surface of the trailer, wherein the first trailer contact feature is operably connected to the electrical system; and
a second trailer contact feature positioned on the exterior surface of the trailer, wherein the second trailer contact feature is spaced apart from the first trailer contact feature, wherein the second trailer contact feature is operably connected to the electrical system, and wherein—
as the trailer backs up to a loading dock, the first trailer contact feature is configured to contact and electrically couple to a first station contact feature of the loading dock and the second trailer contact feature is configured to contact and electrically couple to a second station contact feature of the loading dock, whereby the first trailer contact feature and the second trailer contact feature collectively receive electrical power from an external power source via contact with the first station contact feature and the second station contact feature to electrically power the electrical system.

19. The powered trailer system of claim 18 wherein the electrical system comprises a motor operably coupled to a trailer door of the trailer and configured to move the trailer door between a closed position and an open position.

20. The powered trailer system of claim 18 wherein the electrical system comprises at least one of a battery, controller, antenna, and sensor.
